(19) United States
(12) Patent Application Publication
(10) Pub. No.: US 2017/0220357 A1
(43) Pub. Date: Aug. 3, 2017

(54) IMAGE DISPLAY APPARATUS AND METHOD OF OPERATING THE SAME

(71) Applicant: SAMSUNG ELECTRONICS CO., LTD., Suwon-si (KR)

(72) Inventors: Hyun-seok CHOI, Yongin-si (KR); Cheul-hee HAHM, Seongnam-si (KR); Seok-young YOON, Seoul (KR)

(73) Assignee: SAMSUNG ELECTRONICS CO., LTD., Suwon-si (KR)

(21) Appl. No.: 15/421,599

(22) Filed: Feb. 1, 2017

(30) Foreign Application Priority Data
Feb. 1, 2016 (KR) 10-2016-0012454

(51) Int. Cl. G06F 9/44; G09G 5/00

(52) U.S. Cl. CPC G06F 9/4418; G09G 5/003; G09G 2330/022; G09G 2330/026

(57) ABSTRACT

Provided is an image display apparatus including a sensor configured to sense a power control input with respect to the image display apparatus; a processor; a memory; and one or more instructions stored in the memory, which when executed by the processor, cause the image display apparatus to perform booting according to a state of the image display apparatus in response to the power control input being sensed while the image display apparatus is in an on state, and to enter a suspended state when the booting is completed.

### CROSS-REFERENCE TO RELATED APPLICATION

This application claims priority from Korean Patent Application No. 10-2016-0012454, filed on Feb. 1, 2016 in the Korean Intellectual Property Office, the disclosure of which is incorporated herein by reference in its entirety by reference.

### BACKGROUND

Field

Methods and apparatuses consistent with exemplary embodiments relate to an image display apparatus and a method of operating the image display apparatus, and more particularly, to a booting operation performed by the image display apparatus.

Related Art

An image display apparatus displays an image that is viewable by a user. The user may watch a broadcast through the image display apparatus. The image display apparatus displays an image on a display based on a broadcast signal that is selected from among various broadcast signals based on a user selection. Recently, broadcasting is transitioning from analog broadcasting to digital broadcasting.

Digital broadcasting refers to broadcasting in which a digitized image and an audio signal are transmitted. Compared to analog broadcasting, digital broadcasting is resistant to external noise and thus has reduced data loss, can easily correct errors, and provides high quality audio and images. In addition, unlike analog broadcasting, digital broadcasting may be used for a bi-directional service.

Recently, a smart television (TV) that additionally provides content through other various methods is provided. The smart TV is not manually operated according to user selection but is designed to analyze and provide user-desired items without a user's manipulation.

When a power-on input is detected, the image display apparatus performs a cold booting process to initialize a system according to a state of the image display apparatus. When cold booting is performed, a booting time is relatively long, and thus, a user may be inconvenienced.

### SUMMARY

One or more exemplary embodiments provide an image display apparatus and a method of operating the image display apparatus that always operates with Instant On when a user turns on a power of the image display apparatus.

Additional aspects will be set forth in part in the description which follows and, in part, will be apparent from the description, or may be learned by practice of the presented exemplary embodiments.

According to an aspect of an exemplary embodiment, there is provided an image display apparatus including: a sensor configured to sense a power control input with respect to the image display apparatus; a processor;

a memory; and one or more instructions stored in the memory, which when executed by the processor, cause the image display apparatus to perform booting according to a state of the image display apparatus in response to the power control input being sensed while the image display apparatus is in an on state, and to enter a suspended state when the booting is completed.

The image display apparatus may further include a display, and the one or more instructions, when executed by the processor, may further cause the image display apparatus to turn off the display in response to the power control input being sensed while the image display apparatus is in the on state.

The one or more instructions, when executed by the processor, may further cause the image display apparatus to enter a standby state until a system of the image display apparatus stabilizes in response to the power control input being sensed after the image display apparatus is booted and before the system stabilizes, and to enter the suspended state when the system is stable.

The one or more instructions, when executed by the processor, may further cause the image display apparatus to perform cold booting according to the state of the image display apparatus in response to the power control input being sensed while the image display apparatus is in an on state.

The memory may include a volatile memory and a non-volatile memory, and the instructions to perform the cold booting, when executed by the processor, may further cause the image display apparatus to load an operating system to the volatile memory from the non-volatile memory.

The one or more instructions, when executed by the processor, may further cause the image display apparatus to perform the cold booting when the power-off input is sensed while a software error occurs in the image display apparatus.

The one or more instructions, when executed by the processor, may further cause the image display apparatus to perform the cold booting upon a connection of a main power supply to the image display apparatus.

The memory may include a volatile memory, the one or more programs may be loaded to the volatile memory for execution by the processor, and the instructions to enter the suspended state, when executed by the processor, may further cause the image display apparatus to store, in the volatile memory, operation state information regarding a program being executed in the image display apparatus, and to retain the stored operation state information while in the suspended state.

The one or more instructions, when executed by the processor, may further cause the image display apparatus to, in response to the power control input being sensed while the image display apparatus is in the suspended state, resume from the suspended state to a state before entering the suspended state.

The image display may further include a display, and the one or more instructions, when executed by the processor, may further cause the image display apparatus to turn on the display in response to the power control input being sensed while the image display apparatus is in the suspended state.

According to an aspect of another exemplary embodiment, there is provided a method of operating an image display apparatus, the method including: sensing a power control input with respect to the image display apparatus; performing booting according to a state of the image display apparatus in response to sensing the power control input while the image display apparatus is in an on state; and entering a suspended state when the booting is completed.

The method may further include turning off the display in response to sensing the power control input while the image display apparatus is in the on state.

The performing the booting may include entering a standby state until a system of the image display apparatus stabilizes, in response to the power control input being sensed after the image display apparatus is booted and before the system stabilizes, and the entering the suspended state may include entering the suspended state when the system is stable.

The booting may include performing cold booting according to the state of the image display apparatus in response to sensing the power control input while the image display apparatus is in an on state.

The cold booting may include loading an operating system to a volatile memory of the image display apparatus from a non-volatile memory of the image display apparatus.

The cold booting may be performed in response to the power control input being sensed while a software error occurs in the image display apparatus.

The cold booting may be performed upon a connection of a main power supply to the image display apparatus.

The entering the suspended state may include: storing, in a volatile memory of the image display apparatus, operation state information regarding a program being executed in the image display apparatus, and retaining the stored operation state information while in the suspended state.

The method may further include resuming the image display apparatus from the suspended state to a state before entering the suspended state in response to sensing the power control input while in the suspended state.

The method may further include turning on a display of the image display apparatus in response to sensing the power control input while in the suspended state.

According to an aspect of yet another exemplary embodiment, there I provided a display apparatus configured to selectively operate in an on state and a suspend state, the display apparatus including: a display panel; a power control interface configured to receive a power control input; a processor; and a memory having instructions stored thereon, which when executed by the processor, cause the display apparatus to, in response to receiving the power control input while operating in the on state, store an operational state of the display apparatus in the memory, determine whether a cold boot is required, enter the standby state in response to determining the cold boot is not required, and perform the cold boot in response to determining the cold boot is required, and enter the suspended state after the cold boot is performed.

The display panel may be in a display panel off state while the display apparatus operates in the suspended state.

The memory may have further instructions stored thereon, which when executed by the processor, cause the display apparatus to perform an instant on operation based on the operational state in response to receiving the power control input while the display apparatus operates in the suspended state.

The display panel may be further configured to operate in a standby state, and the memory may have further instructions stored thereon, which when executed by the processor, cause the display apparatus to determine whether the display apparatus is in a stable state after the cold boot is performed, and enter the suspended state in response to determining the display apparatus is in the stable state.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 illustrates an image display apparatus, according to an exemplary embodiment;

FIG. 2 is a block diagram illustrating a configuration of the image display apparatus, according to an exemplary embodiment;

FIG. 3 is a block diagram illustrating a configuration of an image display apparatus, according to an exemplary embodiment;

FIG. 4 is a flowchart of a method of operating the image display apparatus, according to an exemplary embodiment;

FIG. 5 is a flowchart of a method of operating the image display apparatus, according to another exemplary embodiment;

FIGS. 6A, 6B, 6C and 6D are reference diagrams for describing the method of operating the image display apparatus of FIG. 5;

FIG. 7 is a flowchart of a method of operating the image display apparatus, according to another exemplary embodiment;

FIGS. 8A, 8B, 8C and 8D are reference diagrams for describing the method of operating the image display apparatus of FIG. 7;

FIG. 9 is a flowchart of a method of operating the image display apparatus, according to another exemplary embodiment; and

FIGS. 10A, 10B, 10C and 10D are reference diagrams for describing the method of operating the image display apparatus of FIG. 9.

### DETAILED DESCRIPTION

Hereinafter, terms that are used in the specification will be briefly described, and exemplary embodiments will be described in detail.

All terms including descriptive or technical terms which are used herein should be construed as having meanings as understood by one of ordinary skill in the art. Also, the meaning of the selected terms may be described in detail in the detailed description of exemplary embodiments. Thus, the terms used herein have to be defined based on the meaning of the terms together with the description throughout the specification.

Also, when a part “has,” “includes” or “comprises” an element, unless there is a particular description contrary thereto, the part can further include other elements. In the following description, terms such as “unit” and “module” indicate a unit for processing at least one function or operation, wherein the unit and the block may be embodied as hardware or software or embodied by combining hardware and software.

Exemplary embodiments will now be described more fully with reference to the accompanying drawings. However, the exemplary embodiments may be embodied in many different forms, and should not be construed as being limited to the exemplary embodiments set forth herein. Rather, these exemplary embodiments are provided so that this disclosure will be thorough and complete, and will fully convey the concept of the exemplary embodiments to one of ordinary skill in the art. In the following description, well-known functions or constructions are not described in detail since they would obscure the exemplary embodiments with unnecessary detail, and like reference numerals in the drawings denote like or similar elements throughout the specification.

As used herein, the term “and/or” includes any and all combinations of one or more of the associated listed items. Expressions such as “at least one of,” when preceding a list of elements, modify the entire list of elements and do not modify the individual elements of the list.

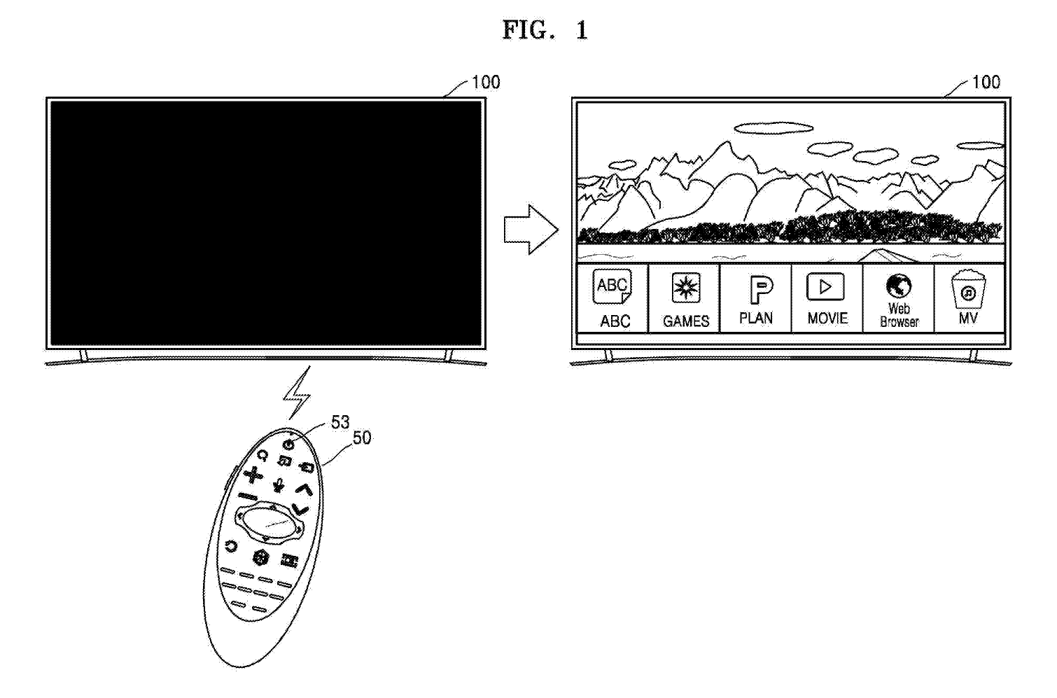

FIG. 1 illustrates an image display apparatus 100, according to an exemplary embodiment.

As illustrated in FIG. 1, the image display apparatus 100 may a television (TV) but is not limited thereto. The image display apparatus 100 may be embodied as an electronic device including a display. For example, the image display apparatus 100 may be embodied as one of various electronic devices, such as a mobile phone, a tablet personal computer (tablet PC), a digital camera, a camcorder, a laptop computer, a desktop, an electronic-book terminal, a terminal for digital broadcasting, a personal digital assistant (PDA), a portable multimedia player (PMP), a navigation device, an MP3 player, a wearable device, or the like. In addition, the image display apparatus 100 may be fixed or portable, and may include a digital broadcasting receiver capable of receiving digital broadcasting.

The image display apparatus 100 may be embodied as a flat display apparatus, a curved display apparatus or a flexible display apparatus. Output resolution of the image display apparatus 100 may include high-definition (HD) resolution, full-HD resolution, ultra-HD resolution, or resolution higher than the ultra-HD resolution.

The image display apparatus 100 according to the present exemplary embodiment may be controlled by a control device 50. The control device 50 may be embodied as one of various devices including a remote controller, a mobile phone, etc., to control the image display apparatus 100.

In addition, the control device 50 may control the image display apparatus 100 by using short-range communication, such as an infrared ray or Bluetooth. The control device 50 may control functions of the image display apparatus 100 by using at least one of a key (including a button), a touchpad, a microphone capable of receiving a user's voice, and a sensor capable of recognizing a motion of the control device 50.

The control device 50 according to the present exemplary embodiment may include a power on/off button 53 for turning on or off power of the image display apparatus 100. The image display apparatus 100 may detect a power control signal corresponding to an input of the power on/off button 53, and then may turn on or off the power of the image display apparatus 100.

When the image display apparatus 100 is on and senses an input of the power control signal, the image display apparatus 100 may turn off a power of the display. In a state in which the power of the image display apparatus 100 is off and the image display apparatus 100 senses an input of the power control signal, as illustrated in FIG. 1, the image display apparatus 100 may turn on the display and may perform cold booting or may operate with Instant On.

Cold booting refers to restarting a system of an image display apparatus from the beginning. For example, when the image display apparatus 100 performs cold booting, the image display apparatus 100 may load software (e.g., an operating system (OS), application programs, etc.) stored in a non-volatile memory to a volatile memory, and may drive the loaded software.

On the other hand, when the image display apparatus 100 operates with Instant On, the image display apparatus 100 may resume from a suspended state to a state before entering the suspended state. In this regard, the suspended state refers to a state in which, by using a Suspend-to-random access memory (RAM) technology, operation state information regarding the software being executed in the image display apparatus 100 is stored and retained in the volatile memory. For example, when the image display apparatus 100 operates with Instant On, the image display apparatus 100 may resume performing an operation of stopped software, based on an operation state information of the software which is stored in the volatile memory.

Accordingly, when the image display apparatus 100 operates with Instant On, the image display apparatus 100 may rapidly perform booting of the image display apparatus 100, compared to cold booting.

The image display apparatus 100 according to the present exemplary embodiment determines whether a state of the image display apparatus 100 requires cold booting in a next booting operation, and if required, the image display apparatus 100 may perform cold booting without a user input of turning on the power of the image display apparatus 100, and thereafter enter the suspended state.

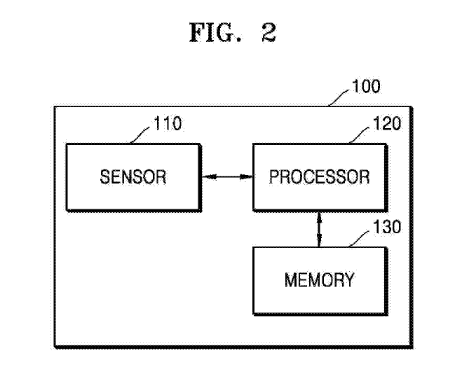

FIG. 2 is a block diagram illustrating a configuration of the image display apparatus 100, according to an exemplary embodiment.

The image display apparatus 100 of FIG. 2 is an example of the image display apparatus 100 of FIG. 1. Referring to FIG. 2, the image display apparatus 100 may include a sensor 110, a processor 120, and a memory 130.

The sensor 110 according to the present exemplary embodiment may receive a user input and may transmit a received signal to the processor 120. The sensor 110 may receive, from the control device 50 shown in FIG. 1, a user input including an input of turning on or off the power of the image display apparatus 100, a channel selection input, a channel-up or down input, a screen setting input, or the like. In addition, the sensor 110 according to the present exemplary embodiment may sense an input through a power on/off button of the image display apparatus 100.

The sensor 110 according to the present exemplary embodiment may sense whether power is supplied to the image display apparatus 100 from an external power source. For example, the sensor 110 may sense whether a power plug of the image display apparatus 100 is connected to, or disconnected from, the external power source. In addition, the sensor 110 may sense whether a power supply from the external power source has been stopped and then resumed. For example, if a blackout occurs, the power supply from the external power may be stopped.

The memory 130 according to the present exemplary embodiment may store various items of data, a program, or an application for driving and controlling the image display apparatus 100. The program stored in the memory 130 may include one or more instructions. The program (the one or more instructions) or the application stored in the memory 130 may be executed by the processor 120.

The memory 130 according to the present exemplary embodiment may include a non-volatile memory and a volatile memory. The non-volatile memory may store various items of data and software (e.g., an operating system (OS), an application program, etc.) for driving and controlling the image display apparatus 100. Even if a power supply is stopped, data stored in the non-volatile memory is not deleted, and the non-volatile memory may include a flash memory such as a NAND flash, a NOR flash, or the like. However, the present disclosure is not limited thereto.

The processor 120 according to the present exemplary embodiment may load the software stored in the non-volatile memory to the volatile memory and may drive the software. The processor 120 may access data related to the software (e.g., the OS, the application program, etc.) loaded to the volatile memory. When a power supply is stopped, data stored in the volatile memory is deleted, and the volatile memory may include a static RAM (SRAM), a dynamic RAM (DRAM), or the like.

The processor 120 according to the present exemplary embodiment functions to control general operations and a signal flow between internal elements of the image display apparatus 100, and to process data. The processor 120 may control operations of the software (e.g., the OS, the application program, etc.) stored in the image display apparatus 100, and may correspond to a central processing unit (CPU). For example, the processor 120 may drive the software by loading the software stored in the non-volatile memory to the volatile memory, and may control the image display apparatus 100 according to a user's command received through the sensor 110 or by using driven software.

The processor 120 may include a graphics processing unit (GPU) for processing graphics that correspond to a video. The processor 120 may be embodied as a System on Chip (SoC) including a core and the GPU. The processor 120 may include a single core, a dual-core, a triple-core, a quad-core, or a multi-core.

In addition, the processor 120 may include a plurality of processors. For example, the processor 120 may be embodied as a main processor and a sub-processor. The sub-processor may operate during a sleep mode.

The processor 120 may perform one or more programs stored in the memory 130, and the one or more programs may each include one or more instructions.

When a power-off input is sensed, the processor 120 according to the present exemplary embodiment may control the display to be turned off. In addition, the processor 120 may determine whether cold booting is required when the image display apparatus 100 is booted next time.

For example, after the image display apparatus 100 is booted (with cold booting or Instant On) and before initialization of functions of software of the image display apparatus 100 is completed, and thus a state of the image display apparatus 100 is unstable, when an input of turning off the power of the image display apparatus 100 is sensed, the processor 120 may determine that the state of the image display apparatus 100 requires cold booting. Alternatively, while an error has occurred in software executed in the image display apparatus 100, when the input of turning off the power of the image display apparatus 100 is sensed, the processor 120 may determine that the state of the image display apparatus 100 requires cold booting. Alternatively, when a power supply from the external power source has been stopped and then is resumed (for example, when the power plug of the image display apparatus 100 has been disconnected from the external power source and then is connected thereto), the processor 120 may determine that the state of the image display apparatus 100 requires cold booting. However, the present disclosure is not limited thereto.

When the state of the image display apparatus 100 requires cold booting, the processor 120 may perform cold boot while the display remains turned off. When cold booting is performed, and the initialization of the functions of the software of the image display apparatus 100 is completed, the processor 120 may enter the suspended state. For example, the image display apparatus 100 may store operation state information regarding software being executed in the image display apparatus 100 in the volatile memory, and may retain the stored operation state information. In this regard, the image display apparatus 100 may supply power only to the volatile memory, and not to hardware elements of the image display apparatus 100, such as the display.

In the suspended state, when an input of turning on the power of the image display apparatus 100 is sensed, the processor 120 may operate with Instant On. For example, the processor 120 may resume the image display apparatus 100 from the suspended state to a state before entering the suspended state. The image display apparatus 100 may resume performing an operation of the stopped software based on the operation state information of the software which is stored in the volatile memory.

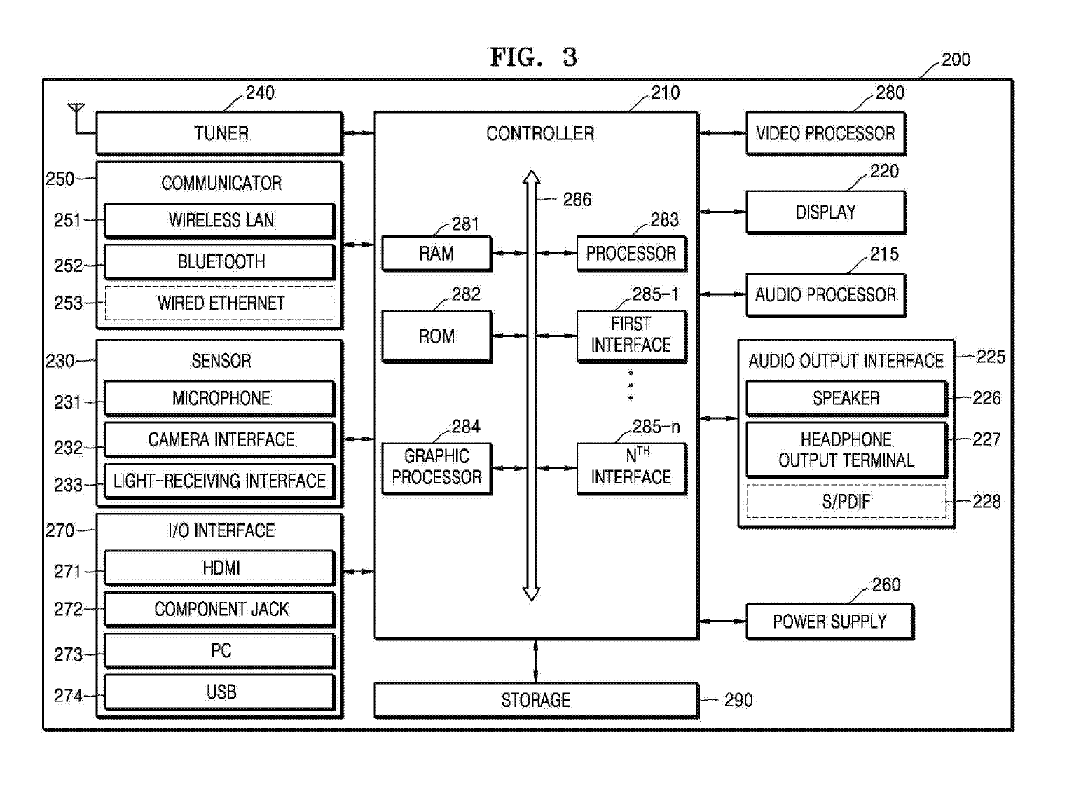

FIG. 3 is a block diagram illustrating a configuration of an image display apparatus 200, according to an exemplary embodiment. The image display apparatus 200 of FIG. 3 may be an example of the image display apparatus 100 of FIG. 1.

Referring to FIG. 3, the image display apparatus 200 according to the present exemplary embodiment may include a controller 210, a display 220, a sensor 230, a video processor 280, an audio processor 215, an audio output interface 225, a power supply 260, a tuner 240, a communicator 250, an input/output (I/O) interface 270, and a storage 290.

The configuration of the image display apparatus 100 described with reference to FIG. 2 may be applied to the configuration of the image display apparatus 200 illustrated in FIG. 3. For example, the sensor 110 of FIG. 2 corresponds to the sensor 230 of FIG. 3, the processor 120 of FIG. 2 corresponds to a processor 283 of FIG. 3, and the memory 130 of FIG. 2 corresponds to the storage 290, a RAM 281, and a read-only memory (ROM) 282 of FIG. 3. Thus, detailed descriptions thereof are omitted.

The video processor 280 may process video data received by the image display apparatus 200. The video processor 280 may perform various image processing such as decoding, scaling, noise filtering, frame rate conversion, resolution conversion, or the like on the video data.

The display 220 generates a driving signal by converting a video signal, a data signal, an on-screen display (OSD) signal, a control signal, or the like, which is processed by the controller 210. The display 220 may be embodied as one of a plasma display panel (PDP), a liquid crystal display (LCD), an organic light-emitting display (OLED), a flexible display, or the like, and may also be embodied as a three-dimensional (3D) display. The display 220 may be configured as a touch screen to be used as both an output device and an input device.

In addition, the display 220 displays, on its screen, a video included in a broadcasting signal received through the tuner 240 by control of the controller 210. The display 220 may display content (e.g., a moving picture) input through the communicator 250 or the I/O interface 270. The display 220 may output, by control of the controller 210, an image stored in the storage 290. In addition, the display 220 may display a voice user interface (UI) to perform a voice recognition task corresponding to a recognized voice. The voice UI may include a voice command guide, or a motion UI (including a user motion guide for motion recognition) of performing a motion recognition task corresponding to a recognized motion.

The audio processor 215 may process audio data. The audio processor 215 may perform various processing such as decoding, amplification, noise filtering, or the like on the audio data. The audio processor 215 may include a plurality of audio processing modules so as to process a plurality of items of audio data corresponding to a plurality of items of content.

The audio output interface 225 outputs, by control of the controller 210, audio included in a broadcasting signal that is received by the tuner 240. The audio output interface 225 may output audio (e.g., music or a sound) that is input via the communicator 250 or the I/O interface 270. Also, the audio output interface 225 may output, by control of the controller 210, audio stored in the storage 290. The audio output interface 225 may include at least one of a speaker 226, a headphone output terminal 227, and a Sony/Philips Digital Interface Format (S/PDIF) output terminal 228. The audio output interface 225 may include a combination of the speaker 226, the headphone output terminal 227, and the S/PDIF output terminal 228.

The power supply 260 may receive main power from an external power source. In addition, the power supply 260 supplies, by control of the controller 210, power, which is input from the external power source, to internal elements of the image display apparatus 200. Also, the power supply 260 may supply, by control of the controller 210, power to the internal elements of the image display apparatus 200 Power may be output from one or more batteries arranged in the image display apparatus 200.

The tuner 240 may tune and select a frequency of a channel that a user wants to receive via the image display apparatus 200, wherein the frequency is obtained by tuning, via amplification, mixing, and resonance, frequency components of a broadcasting signal that is received in a wired or wireless manner. The broadcasting signal includes an audio signal, a video signal, and additional information (e.g., an electronic program guide (EPG)).

The tuner 240 may receive a broadcasting signal in a frequency band corresponding to a channel number (e.g., a cable broadcasting channel no. 506), according to a user input. The broadcasting signal may be, for example, a control signal broadcast from a control apparatus (e.g., the controller 210), e.g., input of a channel number, a channel up or down input, or a channel selection via an EPG screen.

The tuner 240 may receive a broadcasting signal from various sources including ground wave broadcasting, cable broadcasting, satellite broadcasting, internet broadcasting, or the like. The tuner 240 may also receive a broadcasting signal from a source such as analog broadcasting or digital broadcasting. The broadcasting signal received by the tuner 240 is decoded (e.g., audio decoding, video decoding, or additional information decoding) and is split into audio, video, and/or additional information. The split audio, video, and/or additional information may be stored in the storage 290 by control of the controller 210.

The tuner 240 of the image display apparatus 200 may be singular or plural in number. The tuner 240 and the image display apparatus 200 may be embodied as one body (i.e., all-in-one), or the tuner 240 may be embodied as a separate device (e.g., a set-top box) having a tuner to be electrically connected to the image display apparatus 200 or a tuner to be connected to the I/O interface 270.

The communicator 250, by control of the controller 210, may connect the image display apparatus 200 with an external device (e.g., an audio device, etc.). The communicator 250 may include one of a wireless local area network (LAN) 251, Bluetooth 252, and a wired Ethernet 253 so as to correspond to performance and a structure of the image display apparatus 200. Also, the communicator 250 may include a combination of the wireless LAN 251, the Bluetooth 252, and the wired Ethernet 253. The communicator 250 may receive, by control of the controller 210, a control signal from the input device. The control signal may be implemented as one of a Bluetooth-type control signal, a radio frequency (RF)-type control signal, and a Wi-Fi-type control signal.

For example, the communicator 250 may receive, through communication using the Bluetooth 252, a signal corresponding to a Bluetooth-type user input (e.g., a touch, a press, a touch gesture, a voice, or a motion) from the control device 50.

The communicator 250 may further include other short-range communication such as near field communication (NFC), Bluetooth low energy (BLE), or the like.

The sensor 230 may sense a user's voice, a user's image, or interaction of the user. The sensor 230 may include, but is not limited to, a microphone 231, a camera interface 232, and a light-receiving interface 233.

The microphone 231 receives an uttered voice of the user. The microphone 231 may convert the received voice into an electrical signal and may output the electrical signal to the controller 210. The user's voice may indicate a menu or a function of the image display apparatus 200. The microphone 231 may be integrally formed with the image display apparatus 200 or may be separately formed from the image display apparatus 200. The separately-formed microphone 231 may be electrically connected to the image display apparatus 200 through the communicator 250 or the I/O interface 270. One of ordinary skill in the art will appreciate that the microphone 231 may not be used, depending on performance and structure of the image display apparatus 200. The microphone 231 according to the present exemplary embodiment may convert a voice into an electrical signal and may output the electrical signal to the controller 210, the voice corresponding to a command of turning on or off the power of the image display apparatus 200.

The camera interface 232 receives an image (e.g., sequential frames) corresponding to a user's motion including a gesture within a recognition range of a camera. For example, the user's motion may include a part of a body of the user, e.g., a face, expression, a hand, a fist, a finger, etc., or a motion of the part of the body of the user. The camera interface 232 may convert the received image into an electrical signal and may output the electrical signal to the controller 210, by control of the controller 210. The camera interface 232 according to the present exemplary embodiment may convert a motion (a gesture) into an electrical signal and may output the electrical signal to the controller 210, the motion (the gesture) corresponding to a command of turning on or off the power of the image display apparatus 200.

The controller 210 may select a menu displayed on the image display apparatus 200, by using a recognition result of the received motion, or may perform a control corresponding to the recognition result of the received motion. For example, the control may include channel adjustment, volume adjustment, indicator movement, and cursor movement.

The camera interface 232 may be integrally formed with the image display apparatus 200 or may be separately formed from the image display apparatus 200. A separate device including the separately-formed camera interface 232 may be electrically connected to the image display apparatus 200 through the communicator 250 or the I/O interface 270. One of ordinary skill in the art would appreciate that the camera interface 232 may not be used, depending on performance and a structure of the image display apparatus 200.

A light-receiving interface 233 receives an optical signal (including a control signal) from the control device 50 through a light-receiving window of a bezel of the display 220. The light-receiving interface 233 may receive an optical signal corresponding to a user input (e.g., a touch, a press, a touch gesture, a voice, or a motion) from the control device 50. The control signal may be extracted from the optical signal by control of the controller 210.

The light-receiving interface 233 according to the present exemplary embodiment may receive an optical signal corresponding to an input with respect to a power on/off button of the image display apparatus 200.

The I/O interface 270 receives, by control of the controller 210, video (e.g., a moving picture, etc.), audio (e.g., a voice, music, etc.), and additional information (e.g., an EPG, etc.) from an external source of the image display apparatus 200. The I/O interface 270 may include one of a high-definition multimedia interface (HDMI) port 271, a component jack 272, a PC port 273, and a universal serial bus (USB) port 274. The I/O interface 270 may include a combination of the HDMI port 271, the component jack 272, the PC port 273, and the USB port 274. One of ordinary skill in the art would appreciate that a configuration and operations of the I/O interface 270 may vary in the one or more exemplary embodiments.

The controller 210 functions to control general operations of the image display apparatus 200, a signal flow between internal elements of the image display apparatus 100 and to process data. If a user input is received or a preset condition is satisfied, the controller 210 may execute the OS and various applications stored in the storage 290.

The controller 210 may include the RAM 281, the ROM 282, and the processor 283, wherein the RAM 281 stores a signal or data input to the image display apparatus 200 or is used as a storage area corresponding to various operations performed in the image display apparatus 200, and the ROM 282 stores a control program for controlling the image display apparatus 200.

A graphic processor 284 generates a screen including various objects, such as an icon, an image, a text, or the like, by using a calculator and a renderer. The calculator calculates coordinate values of the objects that are to be displayed according to a layout of a screen by using a user input detected by the sensor 230, and calculates attribute values of shapes, sizes, or colors of the objects. Then, the renderer may generate screens with various layouts including the objects based on the attribute values calculated by the calculator. The screen generated by the renderer may be displayed in regions of the display 220.

First through n^{th} interfaces 285-1 through 285-n are connected to the aforementioned elements. One of the first through n^{th} interfaces 285-1 through 285-n may function as a network interface that connects to an external device via a network.

The RAM 281, the ROM 282, the processor 283, the graphic processor 284, and the first through n^{th} interfaces 285-1 through 285-n may be connected to each other via an internal bus 286.

In the present exemplary embodiment, the term “the controller 210 of the image display apparatus 200” may include the processor 283, the ROM 282, and the RAM 281.

The storage 290 may store, by control of the controller 210, various data, programs, or applications for driving and controlling the image display apparatus 200. The storage 290 may store a signal or data which is input or output in response to driving the video processor 280, the display 220, the audio processor 215, the audio output interface 225, the power supply 260, the tuner 240, the communicator 250, the sensor 230, and the I/O interface 270. The storage 290 may store a control program for a control operation by the image display apparatus 200 and the controller 210, an application that is originally provided by a manufacturer or is downloaded from an external source, a graphical user interface (GUI) related to the application, an object (e.g., an image text, an icon, a button, etc.) for providing the GUI, user information, documents, databases, or related data.

In the present exemplary embodiment, the term “storage unit” includes the storage 290, the ROM 282 and the RAM 281 of the controller 210, or a memory card (e.g., a micro secure digital (SD) card or a USB memory) mounted to the image display apparatus 200. Also, the storage 290 may include a non-volatile memory, a volatile memory, a hard disk drive (HDD), or a solid-state drive (SSD).

Although not illustrated, the storage 290 may include a broadcasting receiving module, a channel control module, a volume control module, a communication control module, a voice recognition module, a motion recognition module, a light-receiving module, a display control module, an audio control module, an external input control module, a power control module, a voice database, or a motion database. The aforementioned modules and databases of the storage 290 may be implemented as a plurality of pieces of software in the image display apparatus 200 so as to perform a broadcasting reception control function, a channel control function, a volume control function, a communication control function, a voice recognition function, a motion recognition function, a light-receiving control function, a display control function, an audio control function, an external input control function, a power control function, or a power control function to control power of the other external apparatus that is connected in a wireless manner (e.g., Bluetooth). The controller 210 may perform the aforementioned functions by using the plurality of pieces of software, respectively, which are stored in the storage 290.

The image display apparatus 200 having the display 220 may be electrically connected to a separate external device (e.g., a set-top box) having a tuner. For example, the image display apparatus 200 may be embodied as an analog TV, a digital TV, a 3D TV, a smart TV, an LED TV, an OLED TV, a plasma TV, a monitor, or the like. Of course, these are exemplary, and exemplary embodiments of the image display apparatus 200 are not limited thereto.

The image display apparatus 200 may include at least one sensor (e.g., an illumination sensor, a temperature sensor, etc.) that senses an internal state or an external state of the image display apparatus 200.

The block diagrams of the image display apparatuses 100 and 200 shown FIGS. 2 and 3 are exemplary. The elements shown in the block diagrams may be integrated, added, or omitted according to specification of the image display apparatuses 100 and 200 when they are actually embodied. That is, if required, at least two components may be integrated into one element, or one element may be divided into at least two components. Functions performed by the image display apparatuses 100 and 200 of the block diagrams are provided to describe the exemplary embodiments, and detailed operations thereof or devices do not limit the scope of the present disclosure.

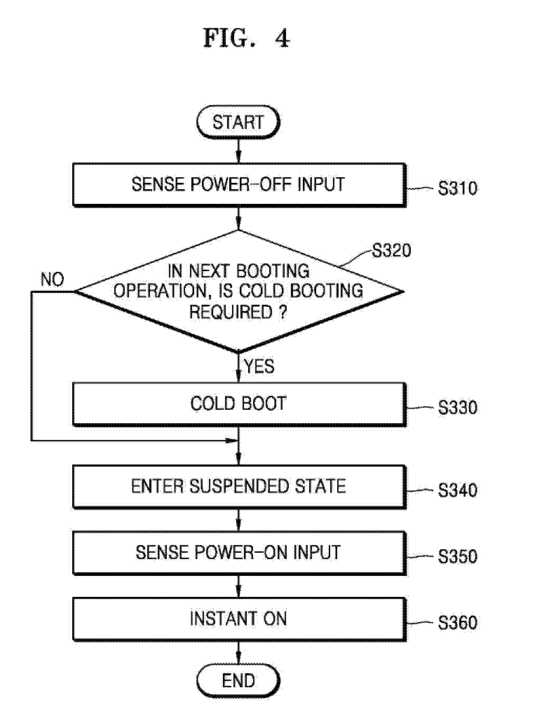

FIG. 4 is a flowchart of a method of operating the image display apparatus 100, according to an exemplary embodiment.

Referring to FIG. 4, the image display apparatus 100 according to the present exemplary embodiment may sense a power-off input (S310).

For example, the image display apparatus 100 may sense a control signal corresponding to an input through a power on/off button of the control device 50 or may sense an input through a power on/off button of the image display apparatus 100. In addition, the image display apparatus 100 may sense a voice corresponding to a power-off command, a motion (a gesture) corresponding to the power-off command, or the like.

In addition, the image display apparatus 100 may sense whether power is supplied from an external power source to the image display apparatus 100, and when a power supply from the external power source is stopped, the image display apparatus 100 may sense the stop as the power-off input.

When the image display apparatus 100 senses the power-off input with respect to the image display apparatus 100, the image display apparatus 100 may turn off the display.

The image display apparatus 100 may determine whether a state of the image display apparatus 100 requires cold booting in a next booting operation (S320).

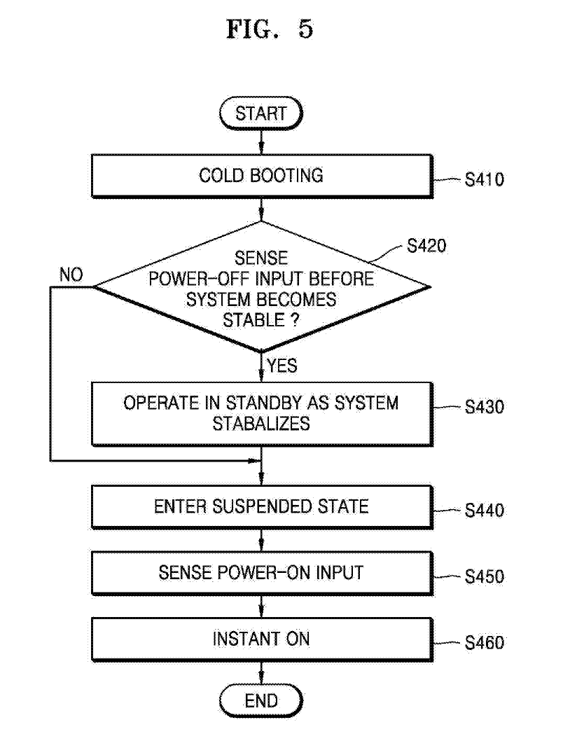

For example, when the image display apparatus 100 senses the power-off input while a system of the image display apparatus 100 is unstable, an error occurs in software, or a memory leak occurs, the image display apparatus 100 may determine cold booting is required. In addition, when there is a demand for initializing the system of the image display apparatus 100 because an external power supply has been stopped and then is resumed, the image display apparatus 100 may determine cold booting is required. Cases that require cold booting in the image display apparatus 100 will be described in detail with reference to FIGS. 5 through 10.

When it is determined cold booting is required, the image display apparatus 100 may perform cold booting while having the display remain turned off (S330).

On the other hand, when it is determined cold booting is not required in the next booting operation (e.g., when the system is stable, an error does not occur in the software, etc.), the image display apparatus 100 may enter a suspended state (S340). Operation S340 will be described below.

When the system stabilizes after cold booting, the image display apparatus 100 may enter the suspended state (S340).

A state in which the system is stable may refer to a state in which initialization of software loaded to the volatile memory is completed and the software is ready to allow the image display apparatus 100 to operate. For example, when a device driver is initialized, software to perform main functions (e.g., a broadcasting receiving function, an image processing function, and an image display function) of the image display apparatus 100 or the like is completed, the image display apparatus 100 may determine that the system has stabilized. However, the present disclosure is not limited thereto.

The suspended state refers to a state in which operation state information of software being executed in the image display apparatus 100 is stored in the volatile memory and the stored operation state information is retained. In this regard, the image display apparatus 100 may supply power only to the volatile memory and may not supply the power to hardware elements of the image display apparatus 100, the hardware elements including the display.

In the suspended state, the image display apparatus 100 may detect an input of turning on power of the image display apparatus 100 (S350).

For example, the image display apparatus 100 may detect a control signal corresponding to an input through a power on/off button of the control device 50 or may sense an input through a power on/off button of the image display apparatus 100. In addition, the image display apparatus 100 may sense a voice corresponding to a power-on command, a motion (a gesture) corresponding to the power-on command, or the like.

When the image display apparatus 100 senses an input of turning on the power, the image display apparatus 100 may operate with Instant On (S360).

The image display apparatus 100 may turn on a power of the display and may resume the image display apparatus 100 to a state before entering the suspended state by using the operation state information stored in the volatile memory. The image display apparatus 100 may resume performing an operation of software that was being executed before the suspended state.

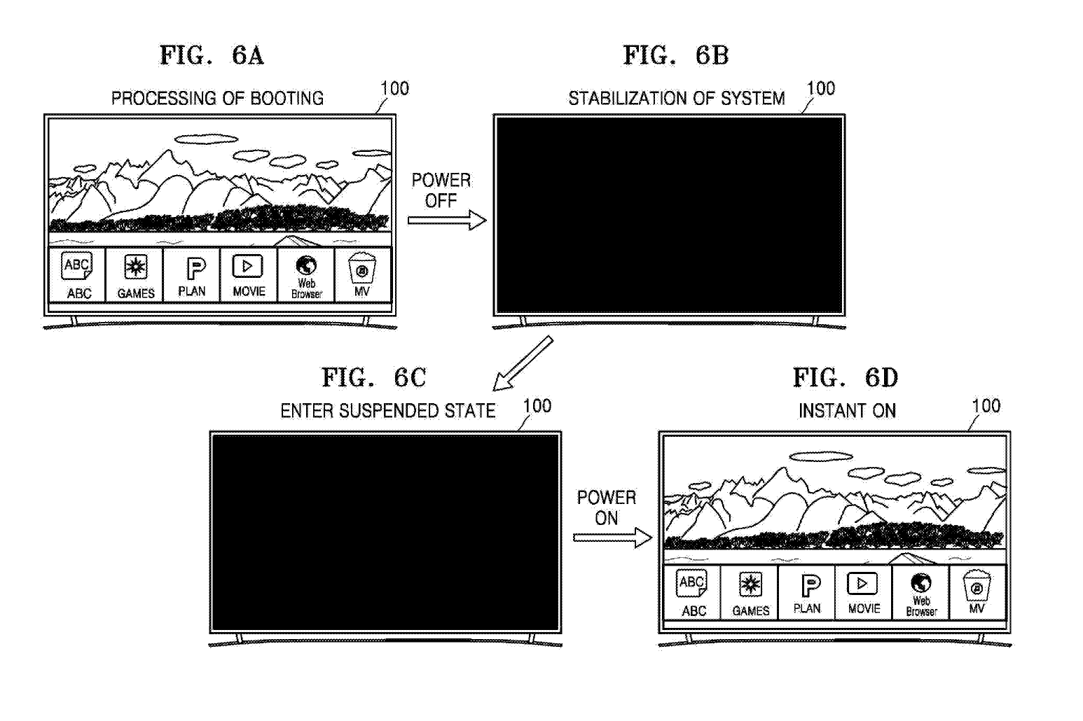

FIG. 5 is a flowchart of a method of operating the image display apparatus 100, according to another exemplary embodiment. FIGS. 6A, 6B, 6C and 6D are reference diagrams for describing the method of operating the image display apparatus 100 of FIG. 5.

Referring to FIG. 5, the image display apparatus 100 may perform booting. In the present exemplary embodiment, booting may include cold booting, Instant-On, or the like. For example, in cold booting, a system of the image display apparatus 100 is initialized. In cold booting, the image display apparatus 100 may load software stored in a non-volatile memory to a volatile memory.

In addition, Instant-On refers to resuming the image display apparatus 100 from a suspended state to a state before entering the suspended state.

When the image display apparatus 100 is booted, the image display apparatus 100 may initialize the software loaded to the volatile memory.

For example, when initialization of software to perform main functions (e.g., a broadcasting receiving function, an image processing function, and an image display function) of an image display apparatus is completed and thus the software is executed, a processed image may be displayed on a display as illustrated in FIG. 6A.

The image display apparatus 100 may sense a power-off input before the system becomes stable (S420).

In the present exemplary embodiment, a state in which the system is stable may refer to a state in which initialization of preset software is completed and the software is ready to allow the image display apparatus 100 to operate. For example, when initialization of a device driver, software to perform main functions (e.g., a broadcasting receiving function, an image processing function, and an image display function) of the image display apparatus 100, or the like is completed, the image display apparatus 100 may determine that the system has stabilized. However, the present disclosure is not limited thereto.

When the image display apparatus 100 senses the power-off input, the image display apparatus 100 may turn off a power of a display as illustrated in FIG. 6B.

When the image display apparatus 100 senses the power-off input before the system is stable, the image display apparatus 100 may operate in standby as long as the system stabilizes (S430).

For example, in the case where initialization of first software, second software, and third software has to be completed to stabilize the system of the image display apparatus 100, and the image display apparatus 100 senses a power-off input when only the initialization of the first software has been completed, the image display apparatus 100 may operate in standby until the initialization of the second software and the third software is completed. Further, during the initialization, the display may remain turned off.

When the system is stable, the image display apparatus 100 may enter the suspended state (S440). In this regard, as illustrated in FIG. 6C, the display remains turned off.

In the suspended state, when the image display apparatus 100 senses an input of turning on the power of the image display apparatus 100 (S450), the image display apparatus 100 may operate with Instant On (S460).

For example, as illustrated in FIG. 6D, the image display apparatus 100 may turn on the power of the display, and may resume the image display apparatus 100 to a state before entering the suspended state, by using operation state information stored in the volatile memory.

Operations S440 through S460 of the flowchart of FIG. 5 correspond to operations S340 through S360 of the flowchart of FIG. 4, thus, detailed descriptions thereof are omitted here.

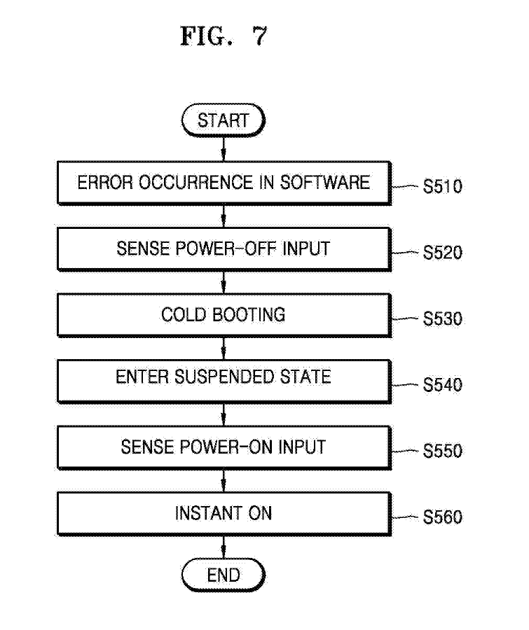

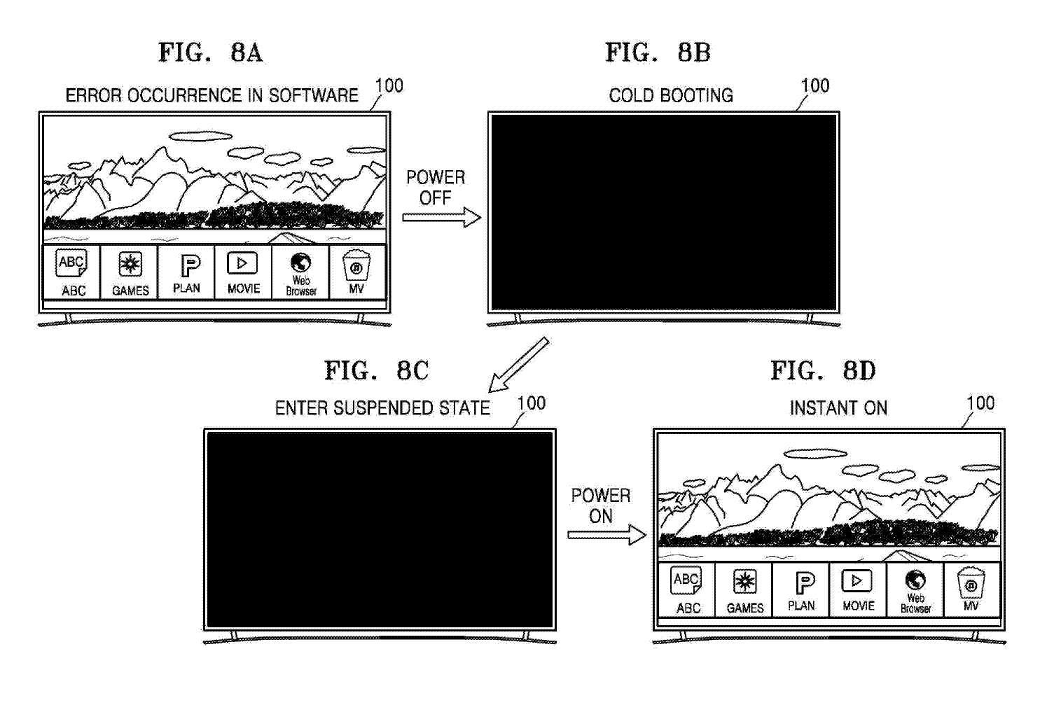

FIG. 7 is a flowchart of a method of operating the image display apparatus 100, according to another exemplary embodiment. FIGS. 8A, 8B, 8C and 8D are reference diagrams for describing the method of operating the image display apparatus 100 of FIG. 7.

Referring to FIG. 7, an error may occur in software having been used in the image display apparatus 100 (S510).

The image display apparatus 100 may check error occurrence in the software by periodically monitoring whether an error has occurred in the software being executed in the image display apparatus 100. For example, as illustrated in FIG. 8A, when executed software is forcibly stopped due to a functional error (an occurrence of a crash) or stops responding, the image display apparatus 100 may determine that the error has occurred in the software.

Alternatively, the image display apparatus 100 may monitor whether a memory leak (that is, a type of leak that occurs when a memory that was dynamically allocated to software due to execution of the software is not properly released and thus a size of the memory is reduced) occurs.

When the image display apparatus 100 detects a power-off input while the error occurs in the software or the memory leak occurs (S520), the image display apparatus 100 may perform cold booting (S530).

When the image display apparatus 100 senses the power-off input, as illustrated in FIG. 8B, the image display apparatus 100 may turn off a power of a display. The image display apparatus 100 may perform cold booting while the power of the display is turned off.

When the initialization of the loaded software is completed and thus the system is stable, the image display apparatus 100 may enter a suspended state (S540). In this regard, as illustrated in FIG. 8C, the display remains turned off.

When the image display apparatus 100 in the suspended state senses an input of turning on power of the image display apparatus 100 (S550), the image display apparatus 100 may operate with Instant On (S560).

For example, as illustrated in FIG. 8D, the image display apparatus 100 may turn on the power of the display, and may resume the image display apparatus 100 to a state before entering the suspended state, by using operation state information stored in the volatile memory.

Operations S540 through S560 of the flowchart of FIG. 7 correspond to operations S340 through S360 of the flowchart of FIG. 4, thus, detailed descriptions thereof are omitted here.

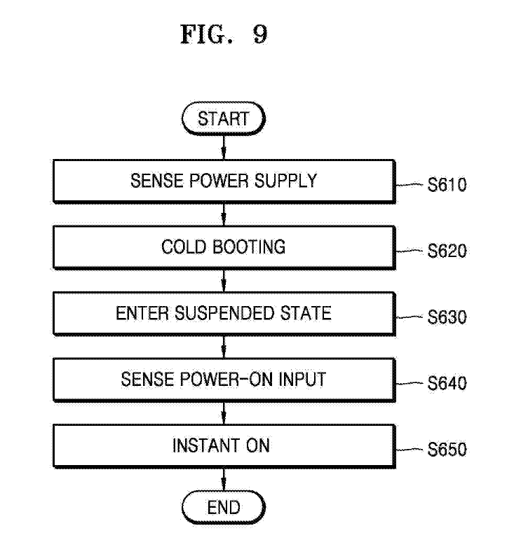

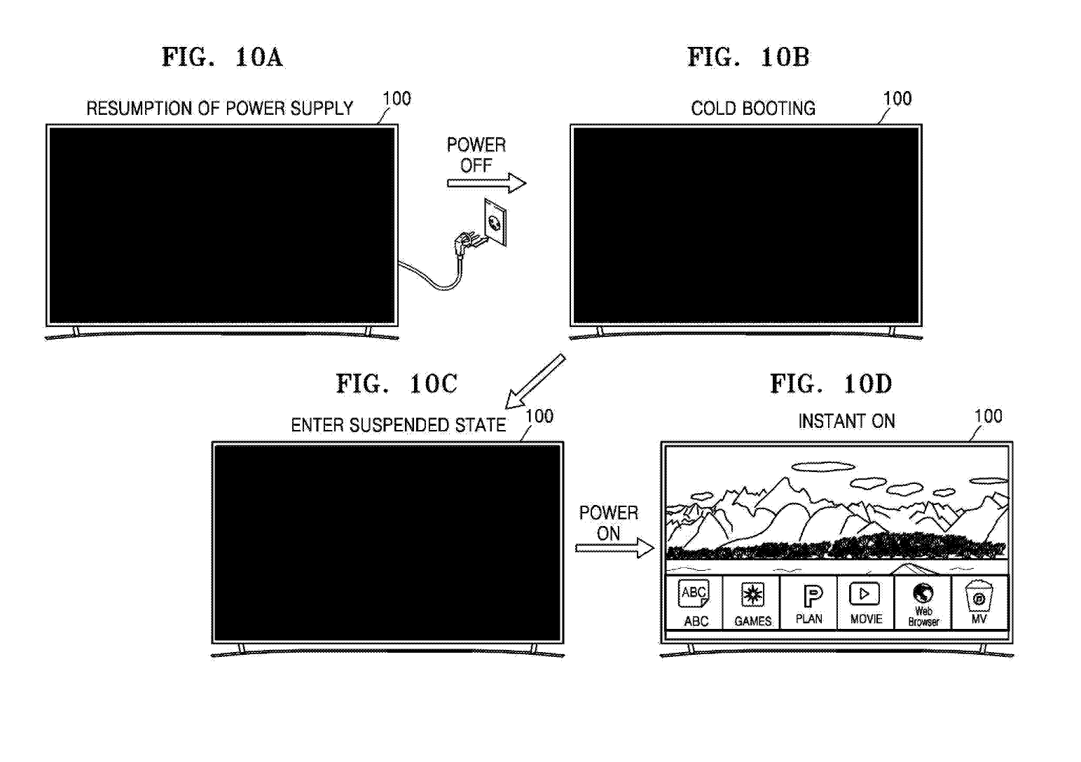

FIG. 9 is a flowchart of a method of operating the image display apparatus 100, according to another exemplary embodiment. FIGS. 10A, 10B, 10C and 10D are reference diagrams for describing the method of operating the image display apparatus 100 of FIG. 9.

Referring to FIG. 9, the image display apparatus 100 may sense a power supply (S610).

The image display apparatus 100 according to the present exemplary embodiment may detect that the power supply from an external power source is resumed. For example, the image display apparatus 100 may detect a case in which a power plug of the image display apparatus 100 is connected to an external power source as illustrated in FIG. 10A, a case in which power has not been supplied and then is supplied to the external power source connected to the image display apparatus 100, or the like. However, the present disclosure is not limited thereto.

When the image display apparatus 100 detects that the power supply has been resumed, the image display apparatus 100 may perform cold booting as illustrated in FIG. 10B (S620). The image display apparatus 100 may perform cold booting while having a power of a display turned off.

When the initialization of the loaded software is completed and thus the system is stable, the image display apparatus 100 may enter a suspended state (S630). In this regard, as illustrated in FIG. 10C, the display remains turned off.

When the image display apparatus 100 in the suspended state senses an input of turning on the power of the image display apparatus 100 (S640), the image display apparatus 100 may operate with Instant On (S650).

For example, as illustrated in FIG. 10D, the image display apparatus 100 may turn on the power of the display, and may resume the image display apparatus 100 to a state before entering the suspended state, by using operation state information stored in the volatile memory.

Operations S630 through S650 of the flowchart of FIG. 9 correspond to operations S340 through S360 of the flowchart of FIG. 4, thus, detailed descriptions thereof are omitted here.

When the image display apparatus according to the one or more exemplary embodiments detects an input of turning on power of the image display apparatus, the image display apparatus may increase a booting speed by always operating with Instant On. By increasing the booting speed, usage convenience of a user may be improved.

The method of operating the image display apparatus according to the one or more exemplary embodiments may also be embodied as programmed commands to be executed in various computer units, and then may be recorded in a computer-readable recording medium. The computer-readable recording medium may include one or more of the programmed commands, data files, data structures, or the like. The programmed commands recorded to the computer-readable recording medium may be particularly designed or configured for the present disclosure or may be well known to one of ordinary skill in the art. Examples of the computer-readable recording medium include magnetic media including hard disks, magnetic tapes, and floppy disks, optical media including compact-disc read-only memories (CD-ROMs) and digital versatile discs (DVDs), magneto-optical media including floptical disks, and hardware designed to store and execute the programmed commands in ROM, RAM, a flash memory, and the like. Examples of the programmed commands include not only machine code generated by a compiler, but also a high-level programming language to be executed in a computer by using an interpreter.

While one or more exemplary embodiments have been described with reference to the figures, it will be understood by one of ordinary skill in the art that various changes in form and details may be made therein without departing from the spirit and scope as defined by the following claims.

What is claimed is:

1. An image display apparatus comprising:
a sensor configured to sense a power control input with respect to the image display apparatus;
a processor;
a memory; and
one or more instructions stored in the memory, which when executed by the processor, cause the image display apparatus to perform booting according to a state of the image display apparatus in response to the power control input being sensed while the image display apparatus is in an on state, and to enter a suspended state when the booting is completed.

2. The image display apparatus of claim 1, further comprising a display,
wherein the one or more instructions, when executed by the processor, further cause the image display apparatus to turn off the display in response to the power control input being sensed while the image display apparatus is in the on state.

3. The image display apparatus of claim 1, wherein the one or more instructions, when executed by the processor, further cause the image display apparatus to enter a standby state until a system of the image display apparatus stabilizes in response to the power control input being sensed after the image display apparatus is booted and before the system stabilizes, and to enter the suspended state when the system is stable.

4. The image display apparatus of claim 1, wherein the one or more instructions, when executed by the processor, further cause the image display apparatus to perform cold booting according to the state of the image display apparatus in response to the power control input being sensed while the image display apparatus is in an on state.

5. The image display apparatus of claim 4, wherein the memory comprises a volatile memory and a non-volatile memory, and
the instructions to perform the cold booting, when executed by the processor, further cause the image display apparatus to load an operating system to the volatile memory from the non-volatile memory.

6. The image display apparatus of claim 4, wherein the one or more instructions, when executed by the processor, further cause the image display apparatus to perform the cold booting when the power-off input is sensed while a software error occurs in the image display apparatus.

7. The image display apparatus of claim 4, wherein the one or more instructions, when executed by the processor, further cause the image display apparatus to perform the cold booting upon a connection of a main power supply to the image display apparatus.

8. The image display apparatus of claim 1, wherein the memory comprises a volatile memory,
the one or more programs are loaded to the volatile memory for execution by the processor, and
the instructions to enter the suspended state, when executed by the processor, further cause the image display apparatus to store, in the volatile memory, operation state information regarding a program being executed in the image display apparatus, and to retain the stored operation state information while in the suspended state.

9. The image display apparatus of claim 8, wherein the one or more instructions, when executed by the processor, further cause the image display apparatus to, in response to the power control input being sensed while the image display apparatus is in the suspended state, resume from the suspended state to a state before entering the suspended state.

10. The image display apparatus of claim 9, further comprising a display,
wherein the one or more instructions, when executed by the processor, further cause the image display apparatus to turn on the display in response to the power control input being sensed while the image display apparatus is in the suspended state.

11. A method of operating an image display apparatus, the method comprising:
sensing a power control input with respect to the image display apparatus;
performing booting according to a state of the image display apparatus in response to sensing the power control input while the image display apparatus is in an on state; and
entering a suspended state when the booting is completed.

12. The method of claim 11, further comprising, turning off the display in response to sensing the power control input while the image display apparatus is in the on state.

13. The method of claim 11, wherein the performing the booting comprises entering a standby state until a system of the image display apparatus stabilizes, in response to the power control input being sensed after the image display apparatus is booted and before the system stabilizes, and
the entering the suspended state comprises entering the suspended state when the system is stable.

14. The method of claim 11, wherein the booting comprises performing cold booting according to the state of the image display apparatus in response to sensing the power control input while the image display apparatus is in an on state.

15. The method of claim 14, wherein the cold booting comprises loading an operating system to a volatile memory of the image display apparatus from a non-volatile memory of the image display apparatus.

16. The method of claim 14, wherein the cold booting is performed in response to the power control input being sensed while a software error occurs in the image display apparatus.

17. The method of claim 14, wherein the cold booting is performed upon a connection of a main power supply to the image display apparatus.

18. The method of claim 11, wherein the entering the suspended state comprises:
storing, in a volatile memory of the image display apparatus, operation state information regarding a program being executed in the image display apparatus, and
retaining the stored operation state information while in the suspended state.

19. The method of claim 18, further comprising resuming the image display apparatus from the suspended state to a state before entering the suspended state in response to sensing the power control input while in the suspended state.

20. A non-transitory computer-readable recording medium having recorded thereon a program for executing the method of claim 11.
